(19) United States
(12) Patent Application Publication
(10) Pub. No.: US 2024/0000641 A1
(43) Pub. Date: Jan. 4, 2024

(54) Wheelchair Lift

(71) Applicant: Jun Shangguan, Changting County (CN)

(72) Inventor: Jun Shangguan, Changting County (CN)

(21) Appl. No.: 17/854,300

(22) Filed: Jun. 30, 2022

(51) Int. Cl. A61G 3/06

(52) U.S. Cl. CPC A61G 3/062

(57) ABSTRACT

A wheelchair lift, comprising: two rotatable screwed rods; two upper screw nuts configured to travel along the respective screw rods with the rotation of the screw rods; two lower screw nuts configured to travel along the respective screw rods with the rotation of the screw rods, the lower screw rods being located below the upper screw nuts; two rods, each joined to a respective lower screw nut; a platform hingedly joined to the rods; a motor configured to rotate the screw rods to selectively lower and raise the upper screw nuts and the lower screw nuts, thereby selectively elevating and lowering the rods and the platform; two first support arms hingedly joined to respective upper screw nuts; and two second support arms hingedly joined to the first support arms and to the platform.

### FIELD OF THE INVENTION

The present invention, in some embodiments thereof, relates to wheelchair lifts for lifting people on wheelchairs from ground level to a desired level.

### BACKGROUND OF THE INVENTION

Many vehicles are required to be wheelchair accessible. Such vehicles are therefore equipped with accessibility systems to help people on wheelchairs embark onto and disembark from the vehicles.

One such accessibility system is a wheelchair lift with a platform. The platform that can be lowered to ground level to allow a person on a wheelchair to move onto the platform, and then lifted to the level of the vehicle floor to enable the person on the wheelchair to move from the platform into the vehicle.

Many existing wheelchair lifts use hydraulic means for moving the platform. Hydraulic system are generally costly and difficult to maintain.

### BRIEF SUMMARY OF EMBODIMENTS OF THE INVENTION

An aim of the present patent application is to provide a wheelchair lift that does not use hydraulic means.

Therefore, an aspect of some embodiments of the present invention relates to a wheelchair lift, comprising two inner rods, a platform, two pulleys, a horizontal winch, a motor, two first support arms, two second support arms. Each inner rod has a connector unit and hinge located at a bottom end of the inner rod. The platform is hingedly joined to both the inner rods. The two pulleys are located above the inner rods. The horizontal winch has two first ropes, each rope extending around a respective one of the pulleys and being joined to a respective one of the connector unit. The motor powers the winch to selectively pull in and release the ropes, thereby selectively elevating and lowering the inner rods and the platform. The two first support arms have first ends and second ends, the first ends being hingedly joined to respective inner rods. The two second support arms have third ends and fourth ends, the third ends being hingedly joined to the second ends of the respective first support arms, and the fourth ends being hingedly joined to the platform, such that the first support arms are selectively pulled toward and away from the inner rods, when the platform is retracted toward the inner rods and released away from the inner rods.

In a variant, the wheelchair lift further comprises a second winch having a second rope joined to the winch on one end of the second rope and to the platform at the other end of the second rope, the second winch being configured to selectively pull in and release the second rope, to rotate the platform with respect to the inner rods.

In another variant, the wheelchair lift is incorporated with a transportation vehicle, wherein the motor is powered by a battery of the transportation vehicle.

Another aspect of some embodiments of the present invention relates to a wheelchair lift, comprising two inner rods, a platform hingedly joined to both of the inner rods, two rotatable screwed rods, two screw nuts, a motor, two first support arms, two second support arms. The platform hingedly joined to both of the inner rods. The two screw nuts are configured to travel along the respective screw rods with the rotation of the screw rods, each screw nuts being linked to a respective one of the inner rods. The motor is configured to rotate the screw rods to selectively lower and raise the screw nuts, thereby selectively lowering and raising the inner rods and the platform. The two first support arms have first ends and second ends, the first ends being hingedly joined to respective inner rods. The two second support arms have third ends and fourth ends, the third ends being hingedly joined to the second ends of the respective first support arms, and the fourth ends being hingedly joined to the platform, such that the first support arms are selectively pulled toward and away from the inner rods, when the platform is retracted toward the inner rods and released away from the inner rods.

In a variant, the wheelchair lift further comprises a winch having a first rope joined to the winch on one end of the first rope and to the platform at the other end of the first rope, the winch being configured to selectively pull in and release the first rope, to rotate the platform with respect to the inner rods.

In another variant, the winch is joined to one of the screw nuts.

In yet another variant, the wheelchair lift is incorporated with a transportation vehicle, wherein the motor is powered by a battery of the transportation vehicle.

In some embodiments of the present invention, the inner rods comprise respective connector units, and the wheelchair lift further comprises two pulleys and two second ropes. The two pulleys are located above the inner rods. Each second rope is joined to a respective one of the screw nuts, extending around a respective one of the pulleys, and being joined to a respective one of the connector units. Each screw nut is linked to the respective one of the inner rods via a respective one of the ropes.

In a variant, the wheelchair lift further comprises a pair of sheaths, each sheath being adjacent to a respective one of the screw rods and corresponding screw nuts. Each sheath surrounds a respective one of the inner rods from a first lateral side and a second lateral side, such that contact between the screw nuts and the respective sheaths prevents the screw nuts from rotating with the screwed rods.

In some embodiments of the present invention, each of the inner rods comprises a respective extension protruding toward and joined to a corresponding one of the screw nuts.

In a variant, the wheelchair lift further comprises a pair of sheaths, each sheath being adjacent to a respective one of the screwed rods and corresponding screw nuts. Each sheath surrounds a respective one of the inner rods from a first lateral side and a second lateral side, while a rear side of each sheath is partially open to enable the extensions to protrude through the sheaths and join to the screw nuts such, that a connection between the screw nuts and the respective extensions prevents the screw nuts from rotating.

A further aspects of some embodiments of the present invention relates to a wheelchair lift, comprising two rotatable screwed rods, two upper screw nuts, two lower screw nuts, two rods, a platform, a motor, two first support arms, and two second support arms. The two upper screw nuts are configured to travel along the respective screw rods with the rotation of the screw rods. The two lower screw nuts are configured to travel along the respective screw rods with the rotation of the screw rods, the lower screw rods being located below the upper screw nuts. The two rods, are joined to respective lower screw nuts. The platform is hingedly joined to both of the rods. The motor is configured to rotate the screw rods to selectively lower and raise the upper screw nuts and the lower screw nuts, thereby selectively elevating and lowering the rods and the platform. The two first support arms have first ends and second ends, the first ends being hingedly joined to respective upper screw nuts. The two second support arms have third ends and fourth ends, the third ends being hingedly joined to the second ends of the respective first support arms, and the fourth ends being hingedly joined to the platform, such that the first support arms are selectively pulled toward and away from the rods, when the platform is retracted toward the rods and released away from the rods.

In a variant, the wheelchair lift further comprises a winch having a rope joined to the winch on one end of the rope and to the platform at the other end of the rope, the winch being configured to selectively pull in and release the rope, to rotate the platform with respect to the rods.

The winch may be joined to one of the upper screw nuts.

In another variant, the wheelchair lift further comprises a pair of sheaths, each sheath surrounding a respective one of the screwed rods from a first lateral side and second lateral side. A front side of each sheath is partially open to enable the upper screw nuts and the lower screw nuts to partially protrude through the sheaths, such that the sheaths prevent the upper screw nuts and the lower screw nuts from rotating.

In yet another variant, the wheelchair lift is incorporated with a transportation vehicle, wherein the motor is powered by a battery of the transportation vehicle.

### BRIEF DESCRIPTION OF DRAWINGS

FIG. 1 is a wheelchair lift including pulleys and a winch, according to some embodiments of the present invention;

FIG. 2 is a wheelchair lift including pulleys and two screw nuts, according to some embodiments of the present invention;

FIG. 3 is a wheelchair lift two screw nuts moving along respective screwed rods, according to some embodiments of the present invention;

FIG. 4 is a wheelchair lift including four screw nut, according to some embodiments of the present invention;

FIG. 5 is a wheelchair lift having a small winch located near an end of a first support arm, according to some embodiments of the present invention;

FIG. 6 illustrates a wheelchair lift in which the platform has been raised to the floor of the vehicle, according to some embodiments of the present invention;

FIG. 7 illustrates a wheelchair lift in which the platform is partially retracted toward the vehicle's opening, according to some embodiments of the present invention;

FIG. 8 illustrates a wheelchair lift in which the platform is fully retracted toward the vehicle's opening, thereby closing the vehicle's opening, according to some embodiments of the present invention; and

FIG. 9 illustrates a motor turning two screwed rods simultaneously via gears, according to some embodiments of the present invention.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

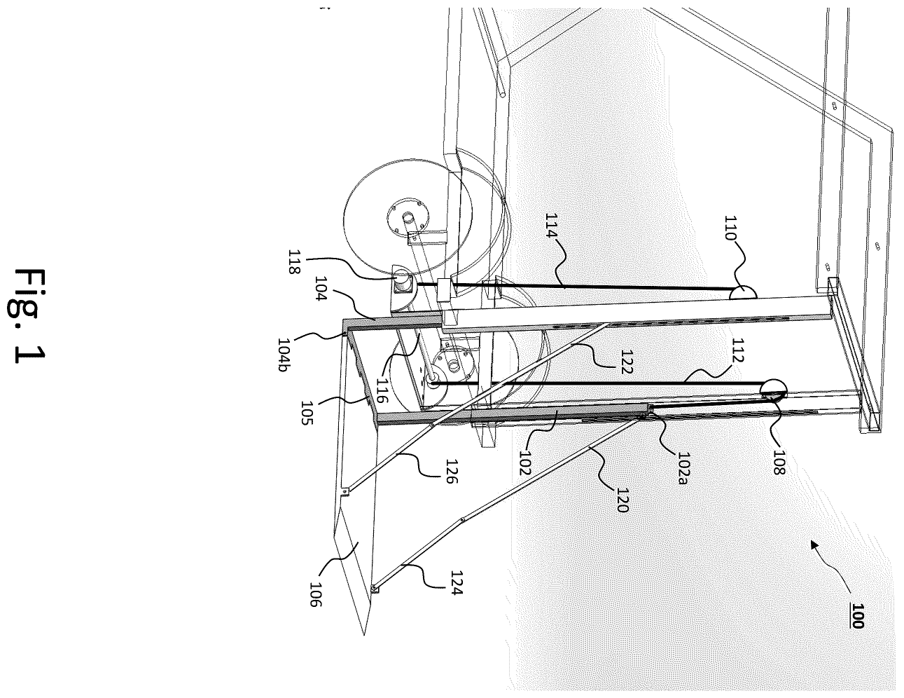

FIG. 1 is a wheelchair lift 100 including pulleys and a winch, according to some embodiments of the present invention;

The wheelchair lift 100 includes two inner rods 102 and 104, a platform 106, two pulleys 108 and 110, two ropes 112 ad 114, a winch 116, a motor 118, two first support arms 120 and 122, and two second support arms 124 and 126.

The first inner rod 102 has a first connector unit 102a and first hinge (not pictured). The first connector unit 102a is shown to be on the top end of the inner rod 102. However, this is not a requirement, as the first connector unit can be located anywhere along the first rod 102. The first hinge is located at a bottom end of the first inner rod 102. The second inner rod 104 has a second connector unit (not pictured) and second hinge 104b. The second hinge 104b is located at a bottom end of the second inner rod 102.

In the embodiments in which the lift 100 is a vehicle-mounted lift, the inner rods 102 and 104 are installed at opposite lateral sides of an opening of a vehicle.

The platform 106 is joined to the hinges of the inner rods 102 and 104. In some embodiments of the present invention, the hinges of the inner rods 102 and 104 are part of a horizontal bar 105 connected to both inner rods 102 and 104. The hinges connect the platform 106 to the horizontal bar 105 in a hinged manner.

The pulleys 108 and 110 are located above the inner rods 102 and 104, respectively. The horizontal winch 116 has two ropes 112 and 114. Each rope extends around a respective the pulley and is joined to a connector unit of the respective inner rod.

The motor 118 powers the winch 116 to selectively pull in and release the ropes 112 and 114. As the ropes 112 and 114 are pulled into the winch, the ropes raise the inner rods 102 and 114, respectively. As the ropes 112 and 114 are released from the winch, the ropes lower the inner rods 102 and 104, respectively. In this manner, the motor 118 selectively elevates and lowers the inner rods 102 and 104 and the platform 116. If the wheelchair lift is based on a vehicle, the motor may be connected to the battery of the vehicle and receive electrical power therefrom.

The two first support arms 120 and 122 have first ends and second ends. The first ends are hingedly joined to inner rods 102 and 104, respectively. The two second support arms 124 and 126 have third ends and fourth ends. Each third end is hingedly joined to the second end of the respective first support arms (120, 122). Each fourth end is hingedly joined to the platform 106. In this manner, the first support arms (120, 122) are pulled toward and away from the respective inner rods (102, 104), when the platform is retracted toward the respective inner rods and release from respective the inner rods.

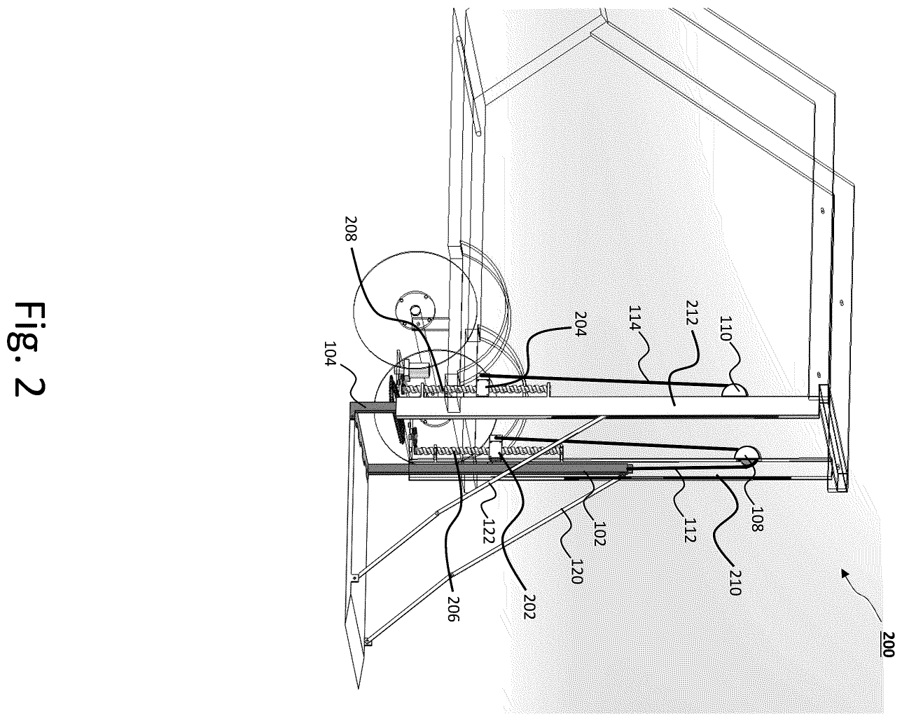

FIG. 2 is a wheelchair lift 200 including pulleys and two screw nuts, according to some embodiments of the present invention.

The wheelchair lift 200 is similar to the wheelchair lift 100 of FIG. 1. The difference lies in the fact that wheelchair lift 200 does not include a winch. Rather, the ends of the ropes 112 and 114 are joined to screw nuts 202 and 204, respectively. In other terms, the nuts 202 and 204 are connected to the inner rods 102 and 104 via ropes 112 and 114 and pulley 108 and 110, respectively. The screw nuts 202 and 204 are mounted on respective screwed rods 206 and 208. The screw rods 206 and 208 are configured to be rotated around their axes, and the screw musts 202 and 204 are configured to travel upwards and downwards along the screwed rots 206 and 208. The direction of rotation of the screwed rods determines the direction of rotation of the screw nuts. The motor 108 controls the rotation of the screwed rods 206 and 208, so that the screwed rods 206 and 208 rotate simultaneously in the same direction and at the same rate. In this manner, the screw nuts 202 and 204 travel up and down the respective screwed rods at the same rate and in the same direction.

In some embodiments of the present invention, the screwed rods and screw nuts 202 and 204 are located adjacent of sheaths 210 and 212, respectively. The sheaths 210 and 212 surround the inner rods 102 and 104, respectively, from three sides: rear, first lateral side, and second lateral side. The front side of each sheath is partially open to enable the support arms 120 and 122 to protrude through the sheaths, while joined to the inner rods 102 and 104. The contact between the first screw nut 202 and the first sheath 210 prevents the first screw nut 202 from rotating with the first screwed rod 206, and therefore causes the first screw nut 202 to move along the length of the first screwed rod 206 when the first screwed rod 206 rotates. The contact between the second screw nut 204 and the second sheath 212 prevents the second screw nut 204 from rotating with the second screwed rod 210, and therefore causes the second screw nut 204 to move along the length of the second screwed rod 208 when the first screwed rods 208 rotates.

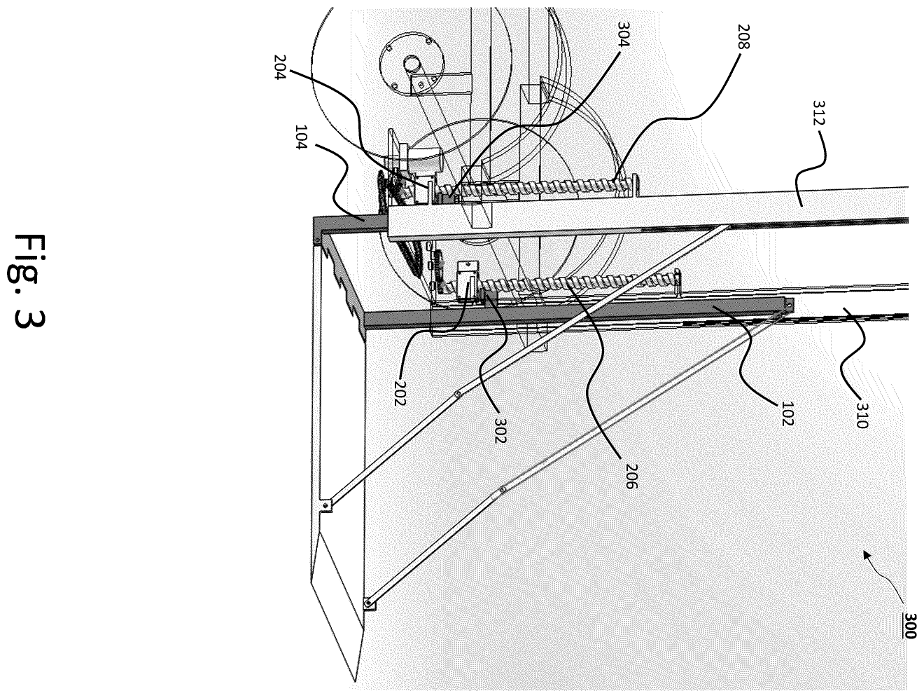

FIG. 3 is a wheelchair lift 300 with two screw nuts moving respective rods, according to some embodiments of the present invention.

The wheelchair lift 300 is similar to the wheelchair lift 200 of FIG. 2. The difference lies in the fact that the wheelchair lift 300 lacks ropes and pulleys. Rather, the screw nuts 202 and 204 are directly connected to the respective inner rods 102 and 104. Each inner rod has an extension protruding toward and being joined to the respective screw nut. The first inner rod 102 has a first extension 302 joined to the first screw nut 202, while the second inner rod 104 has a second extension 304 joined to the second screw nut 204. By virtue of the physical link between the extensions and the screw nuts, the upward and downward motion of the screw nuts along the screwed rods causes the upward and downward motion of the inner rods.

In some embodiments of the present invention, the wheelchair lift 300 includes sheaths 310 and 312, which surround the inner rods 102 and 104, respectively, from the first lateral side, and second lateral side. The front side of each sheath is partially open to enable the support arms 120 and 122 to protrude through the sheaths, while joined to the inner rods 102 and 104. The rear side of each sheath is partially open to enable the extensions 302 and 304 to protrude through the sheaths and join to the screw nuts 202 and 204, respectively. The sheaths 310 and 312 function as rails that limit the motion of the inner rods to the vertical axis. By virtue of the connection between the extensions 302 and 304 and the respective screw nuts 202 and 204, the screw nuts 202 and 204 are maintained at the same orientation and prevented from rotating with the screwed rods. In this manner, rotation of the screwed rods causes vertical motion of the screw nuts.

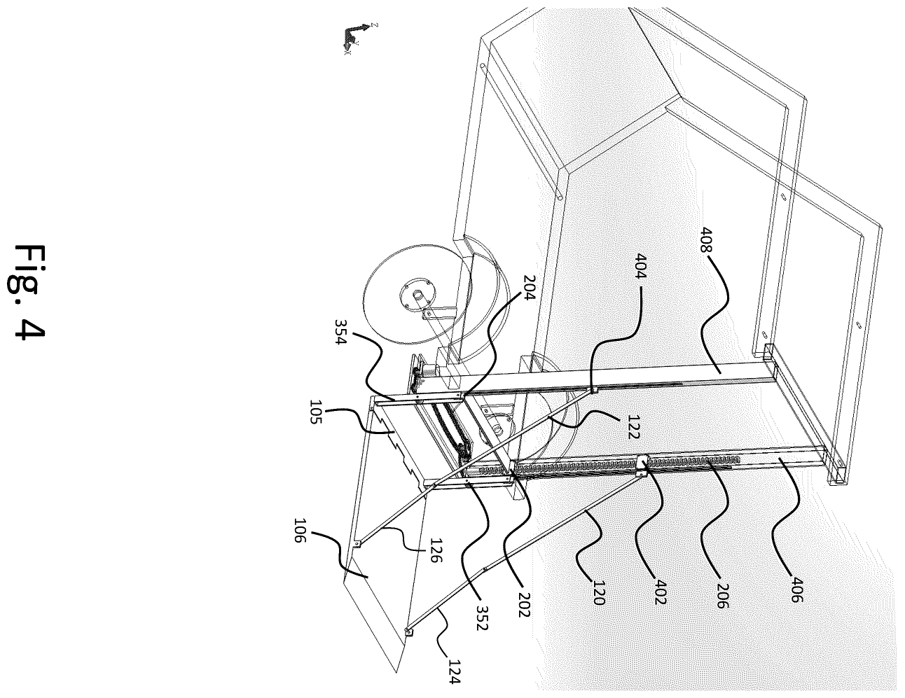

FIG. 4 is a wheelchair lift 400 including four screw nuts, according to some embodiments of the present invention.

The wheelchair lift 400 includes two rotatable screwed rods (of which the first screwed rod is 206 pictured, while the second is not shown since it is inside a sheath 408), two upper screw nuts 402 and 404, two lower screw nuts 202 and 204, two rods 352 and 354, a platform 106, a motor 108, two first support arms 120 and 122, and two second support arms 124 and 126.

The two upper screw nuts 402 and 404 are mounted on the rotatable screwed rods configured to travel along the respective screw rods with the rotation of the screw rods. The two lower screw nuts 202 and 204 are configured to travel along the respective screw rods with the rotation of the screw rods. The lower screw rods 202 and 204 are located a certain distance below the respective upper screw nuts 402 and 404.

The two rods 352 and 354 are each joined to a respective lower screw nut. Each rod has a hinge located at a bottom end of the rod, as described above. The platform 106 is joined to the hinges of the inner rods, as described above. In some embodiments of the present invention, the hinged connection between the rods 352 and 354 and the platform 106 occurs via the horizontal bar 105, as described above.

The motor 108 is configured to rotate the screw rods to selectively lower and raise the upper screw nuts and the lower screw nuts, thereby selectively elevating and lowering the rods and the platform.

The two first support arms 120 and 122 have first ends and second ends. The first ends being are joined to respective upper screw nuts 402 and 404. The two second support arms 124 and 126 have third ends and fourth ends. The third ends are hingedly joined to the second ends of the respective first support arms 124 and 126. The fourth ends are hingedly joined to the platform 106. In this manner, the first support arms are selectively pulled toward and away from the rods, when the platform 106 is retracted toward the rods 352 and 354 and released away from the rods 352 and 354.

In some embodiments of the present invention, the wheelchair lift 400 includes sheaths 406 and 408, which surround the screwed rods 206 and 208, from the first lateral side and second lateral side. The front side of each sheath is partially open to enable the upper screw nuts 402 and 404 to partially protrude through the sheaths, and enable joining the upper screw nuts 402 and 404 to first support arm 120 and 122. The lower screw nuts 202 and 204 also protrude from the open front of the sheaths 406 and 408, respectively, to connect to the rods 352 and 354. The sheaths 406 and 408 prevent the upper screw nuts 402 and 404 and the lower screw nuts 202 and 204 from rotating with the screwed rods 206 and 208. In this manner, rotation of the screwed rods causes vertical motion of the upper screw nuts and lower screw nuts.

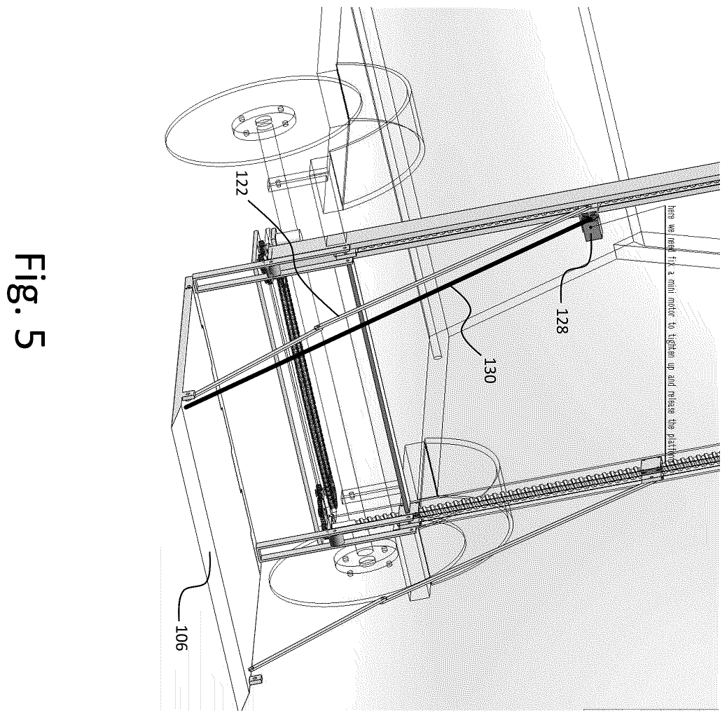

FIG. 5 is a wheelchair lift having a small winch located near an end of a first support arm, according to some embodiments of the present invention;

In some embodiments of the present invention, as shown in FIG. 5, and applied to any one of FIGS. 1-4, a second winch 128 is included, and may be mounted in the vicinity of the first end of one of the first support arms 120. The second winch 128 has a third rope 130 which is joined to the winch on one end and to the platform 106 at the other end. The second winch selectively pulls in and releases the third rope, to rotate the platform about the hinges.

In the embodiments in which screw nuts are present and joined to the first support arm 120 (FIGS. 2-4), the second winch 128 may be joined to one of the screw nuts joined to the first support arm.

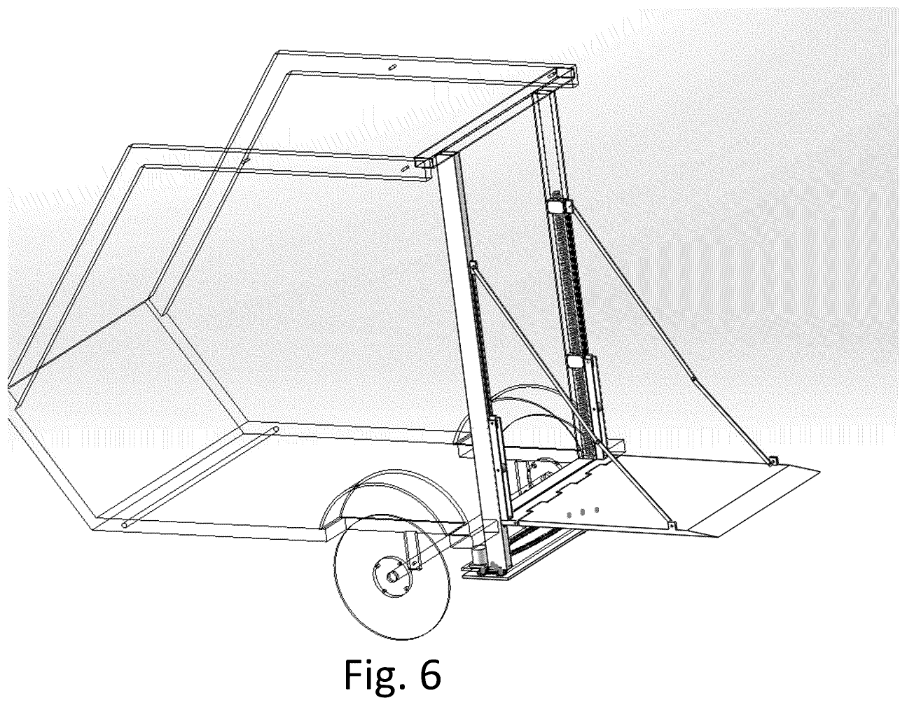

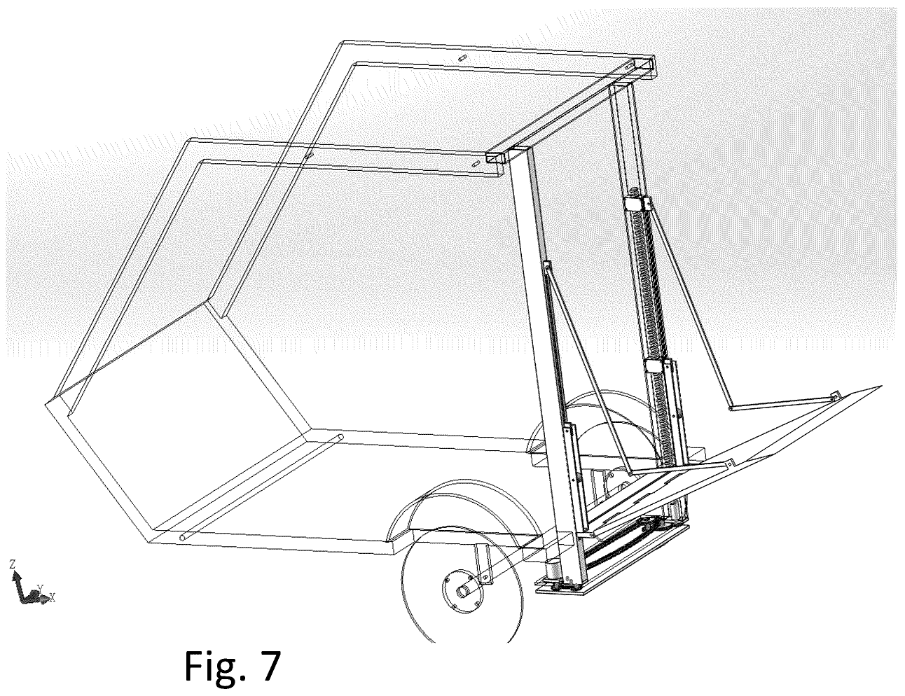

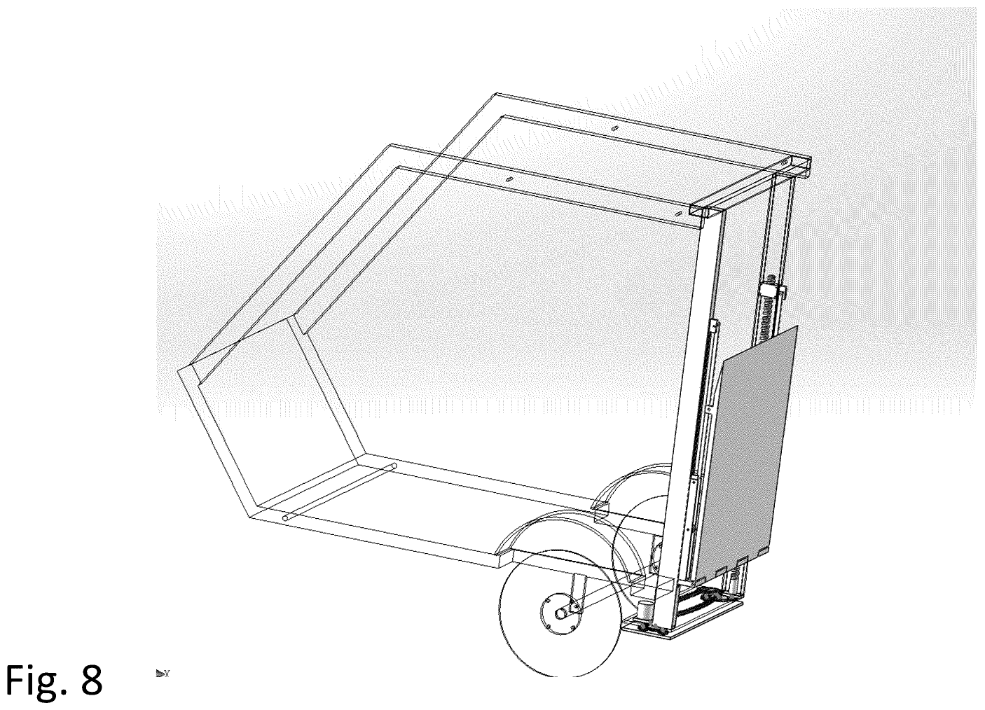

FIG. 6 illustrates a wheelchair lift in which the platform has been raised to the floor of the vehicle, according to some embodiments of the present invention. FIG. 7 illustrates a wheelchair lift in which the platform is partially retracted toward the vehicle's opening, according to some embodiments of the present invention. FIG. 8 illustrates a wheelchair lift in which the platform is fully retracted toward the vehicle's opening, thereby closing the vehicle's opening, according to some embodiments of the present invention. FIGS. 6-8 may be applied to any of the embodiments described above in FIGS. 1-4.

It should be noted that in the figures, the lift is located on the rear side of vehicle. However, the scope of the present invention extends to the embodiments in which the lift is located on the lateral side of the vehicle as well.

FIGS. 1-4 s show the platform 106 to be on a ground level. In FIG. 6, the platform 106 is raised to a desired upper level, in a manner described above for each of the figures. The upper level may be, for example, the floor of the vehicle.

Once the person has moved away from the platform (e.g., has entered the vehicle), the platform 106 is pulled to a vertical orientation, as seen in FIGS. 7 and 8. This is possible due to: (a) the hinged connection between the first support arms (120, 122) and their respective inner rods (FIGS. 1-3) or upper screw nuts (FIG. 4); (b) the hinged connection between the first support arms (120, 122) and their respective second support arms (124, 126); (c) the hinged connection between the second support arms (124, 126) and the platform 106; (d) the hinged connection between the platform 106 and the inner rods (FIGS. 1-3) or the rods (FIG. 4). If the lift is vehicle-based, orienting the platform 106 blocks the opening to the vehicle, and enables the vehicle to move safely lowering the risk of passengers falling from the vehicle through the vehicle's opening.

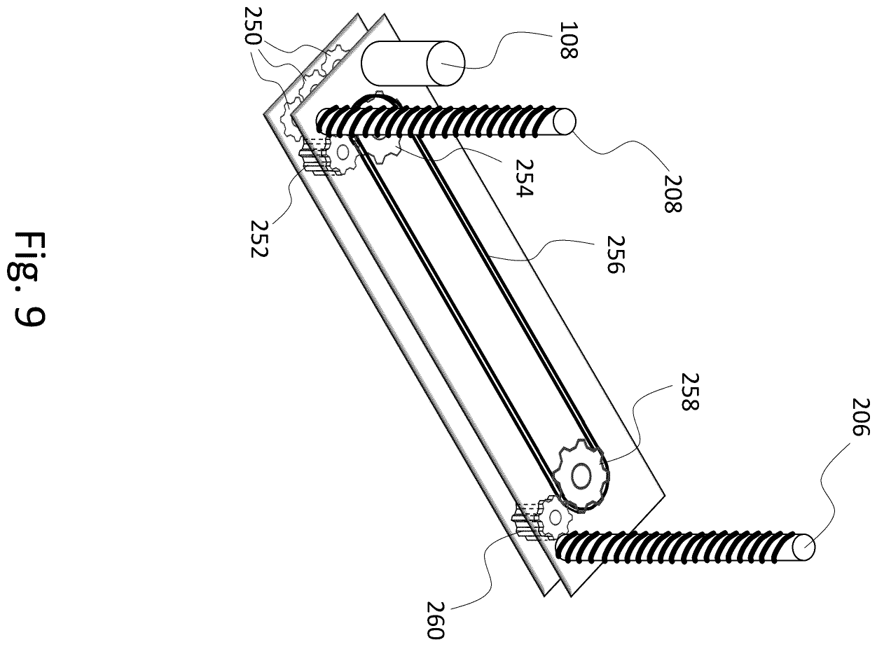

FIG. 9 illustrates a motor turning two screwed rods simultaneously via gears, according to some embodiments of the present invention.

In a non-limiting example, as shown in FIG. 9 (and applied to FIG. 2-4), the motor 108 is connected to a gear apparatus 250 and turns the one or more gears forming the gear apparatus 250. One of the gears of the gear apparatus 250 is enmeshed with a first output gear 252, which is enmeshed with the second screwed rod 208 and with a first transfer gear 254. Turning of the gear 252 turns the second screwed rod 208 and the first transfer gear 254. The first transfer gear 254 is connected via a chain 256 to a second transfer gear 258. In this manner, the turning of the first transfer gear 254 causes the turning of the second transfer gear 258. The second transfer gear 258 is enmeshed with a second output gear 260. The second output gear 260 is enmeshed with the first screwed rod 206. By setting the first output gear 252 and the second output gear 260 to be equal to each other, and by setting the first transfer gear 254 and the second transfer gear 258 to be equal to each other, the result is that as the motor 108 rotates, the screwed rods 206 and 208 can be rotated at the same rate and in the same direction. The presence of the transfer gears 254 and 258 and the chain 256 enables positioning the screwed rods 206 and 208 at a desired distance from each other.

It should be noted that while the wheelchair lifts described above were linked to vehicles, this is not a requirement. In fact, the scope of the present invention extends to wheelchair lifts that can be installed in any location having a ground level and a second level higher than the ground level, for lifting a person between the ground level and higher level.

Although the invention is described above in terms of various exemplary embodiments and implementations, it should be understood that the various features, aspects, time measurements, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

1. A wheelchair lift, comprising:
two inner rods, each inner rod having a connector unit and hinge located at a bottom end of the inner rod;
a platform hingedly joined to both the inner rods;
two pulleys located above the inner rods;
a horizontal winch having two first ropes, each rope extending around a respective one of the pulleys and being joined to a respective one of the connector unit;
a motor powering the winch to selectively pull in and release the ropes, thereby selectively elevating and lowering the inner rods and the platform;
two first support arms having first ends and second ends, the first ends being hingedly joined to respective inner rods;
two second support arms having third ends and fourth ends, the third ends being hingedly joined to the second ends of the respective first support arms, and the fourth ends being hingedly joined to the platform, such that the first support arms are selectively pulled toward and away from the inner rods, when the platform is retracted toward the inner rods and released away from the inner rods.

2. The wheelchair lift of claim 1, further comprising:
a second winch having a second rope joined to the winch on one end of the second rope and to the platform at the other end of the second rope, the second winch being configured to selectively pull in and release the second rope, to rotate the platform with respect to the inner rods.

3. The wheelchair lift of claim 1 being incorporated with a transportation vehicle, wherein the motor is powered by a battery of the transportation vehicle.

4. A wheelchair lift, comprising:
two inner rods;
a platform hingedly joined to both of the inner rods;
two rotatable screwed rods;
two screw nuts configured to travel along the respective screw rods with the rotation of the screw rods, each screw nuts being linked to a respective one of the inner rods;
a motor configured to rotate the screw rods to selectively lower and raise the screw nuts, thereby selectively lowering and raising the inner rods and the platform;
two first support arms having first ends and second ends, the first ends being hingedly joined to respective inner rods;
two second support arms having third ends and fourth ends, the third ends being hingedly joined to the second ends of the respective first support arms, and the fourth ends being hingedly joined to the platform, such that the first support arms are selectively pulled toward and away from the inner rods, when the platform is retracted toward the inner rods and released away from the inner rods.

5. The wheelchair lift of claim 4, further comprising:
a winch having a first rope joined to the winch on one end of the first rope and to the platform at the other end of the first rope, the winch being configured to selectively pull in and release the first rope, to rotate the platform with respect to the inner rods.

6. The wheelchair lift of claim 5, wherein the winch is joined to one of the screw nuts.

7. The wheelchair lift of claim 4 being incorporated with a transportation vehicle, wherein the motor is powered by a battery of the transportation vehicle.

8. The wheelchair lift of claim 4, wherein the inner rods comprise respective connector units, the wheelchair lift further comprising:
two pulleys located above the inner rods;
two second ropes, each second rope being joined to a respective one of the screw nuts, extending around a respective one of the pulleys, and being joined to a respective one of the connector units;
wherein each screw nut is linked to the respective one of the inner rods via a respective one of the ropes.

9. The wheelchair lift of claim 8, further comprising a pair of sheaths, each sheath being adjacent to a respective one of the screw rods and corresponding screw nuts;
wherein each sheath surrounds a respective one of the inner rods from a first lateral side and a second lateral side, such that contact between the screw nuts and the respective sheaths prevents the screw nuts from rotating with the screwed rods.

10. The wheelchair lift of claim 4, wherein each of the inner rods comprises a respective extension protruding toward and joined to a corresponding one of the screw nuts.

11. The wheelchair lift of claim 10, further comprising a pair of sheaths, each sheath being adjacent to a respective one of the screwed rods and corresponding screw nuts;
wherein each sheath surrounds a respective one of the inner rods from a first lateral side and a second lateral side, while a rear side of each sheath is partially open to enable the extensions to protrude through the sheaths and join to the screw nuts such, that a connection between the screw nuts and the respective extensions prevents the screw nuts from rotating.

12. A wheelchair lift, comprising:
two rotatable screwed rods;
two upper screw nuts configured to travel along the respective screw rods with the rotation of the screw rods;
two lower screw nuts configured to travel along the respective screw rods with the rotation of the screw rods, the lower screw rods being located below the upper screw nuts;
two rods, each joined to a respective lower screw nut;
a platform hingedly joined to both of the rods;
a motor configured to rotate the screw rods to selectively lower and raise the upper screw nuts and the lower screw nuts, thereby selectively elevating and lowering the rods and the platform;
two first support arms having first ends and second ends, the first ends being hingedly joined to respective upper screw nuts;
two second support arms having third ends and fourth ends, the third ends being hingedly joined to the second ends of the respective first support arms, and the fourth ends being hingedly joined to the platform, such that the first support arms are selectively pulled toward and away from the rods, when the platform is retracted toward the rods and released away from the rods.

13. The wheelchair lift of claim 12, further comprising:
a winch having a rope joined to the winch on one end of the rope and to the platform at the other end of the rope, the winch being configured to selectively pull in and release the rope, to rotate the platform with respect to the rods.

14. The wheelchair lift of claim 13, wherein the winch is joined to one of the upper screw nuts.

15. The wheelchair lift of claim 12, further comprising a pair of sheaths, each sheath surrounding a respective one of the screwed rods from a first lateral side and second lateral side;
wherein a front side of each sheath is partially open to enable the upper screw nuts and the lower screw nuts to partially protrude through the sheaths, such that the sheaths prevent the upper screw nuts and the lower screw nuts from rotating.

16. The wheelchair lift of claim 12 being incorporated with a transportation vehicle, wherein the motor is powered by a battery of the transportation vehicle.
